(19) United States
(12) Patent Application Publication
(10) Pub. No.: US 2019/0055142 A1
(43) Pub. Date: Feb. 21, 2019

(54) PORTABLE ELECTROLYZING SYSTEM

(71) Applicant: Spraying Systems Co., Wheaton, IL (US)

(72) Inventors: James I. Moyer, Kokomo, IN (US); James B. Swartz, Noblesville, IN (US); John Hazelwood, Anderson, IN (US); Kevin Shane, Glendale Heights, IL (US); Julie Thorpe, Glendale Heights, IL (US)

(21) Appl. No.: 16/079,611

(22) PCT Filed: Mar. 10, 2017
(86) PCT No.: PCT/US17/21885

§ 371 Date: Aug. 24, 2018

Related U.S. Application Data
(60) Provisional application No. 62/307,002, filed on Mar. 11, 2016.

(51) Int. Cl. C02F 1/461; C02F 1/469; C25B 1/46; C25B 15/02; C25B 9/10; C25B 15/08

(52) U.S. Cl. CPC C02F 1/46104; C02F 1/4693; C25B 15/08; C25B 15/02; C25B 9/10; C25B 1/46

(57) ABSTRACT

An electrolyzing system for electrolyzing a brine solution is provided that includes a housing defining a brine compartment and a fresh water compartment. A first electrolytic cartridge is arranged in the brine compartment and includes an electrically charged electrode. The first electrolytic cartridge includes an inlet in fluid communication with the fresh water compartment and an outlet that is fluid communication with a dispensing system. An electrically powered pump directs fresh water from the fresh water compartment to the inlet of the cartridge. A control system is configured to direct electric power from a power supply to the pump when flow of fresh water from the fresh water compartment to the inlet of the cartridge is detected and configured to stop supplying electric power to the pump when flow of fresh water from the fresh water compartment to the inlet of the cartridge is not detected.

### FIELD OF THE INVENTION

The present invention relates generally to apparatuses and systems for producing electrochemically activated solutions (e.g., electrolyzed water). More particularly, the present invention relates to simultaneously producing alkaline electrolyzed water and acidic electrolyzed water.

### BACKGROUND

Systems and methods are known that electrolyze water containing alkali salts to produce acidic electrolyzed water and alkaline electrolyzed water. Acidic electrolyzed water, which typically has a pH between about 3.0 and about 6.5, generally comprises a disinfectant that is increasingly used in a variety of sanitizing applications including in the medical, agricultural and food processing industries and in other institutional environments. The alkaline (i.e., basic) electrolyzed water also has a disinfecting as well as a detergent and denaturing effect and is useful in cleaning oil and grease stains. Sodium chloride is commonly used as the alkali salt that is dissolved in the water because it produces acids and bases that are environmentally friendly, potent and low in cost.

The known systems and methods for electrolyzing water can be complex, even difficult, to operate. Some known systems and methods require large-scale pre-treatment of water prior to entering the known systems. For example, some electrolytic processes require exceedingly pure water in order to consistently produce electrolyzed water product(s). Examples of large-scale pre-treatment include, but are not limited to, distillation, deionization, membrane treatment, and the like.

A need for smaller quantity production of electrolyzed water products exists in many applications. For example, households and smaller commercial establishments such as restaurants, service stations and grocery stores have a need for acidic electrolyzed water and alkaline electrolyzed water cleaning products, but at significantly lower quantities than are typically produced by commercially available water electrolyzing systems. Such commercially available water electrolyzing systems generally produce volumes of electrolyzed water products that are appropriate for much larger establishments, such as industrial facilities, hospitals, hotels and other institutional settings. The use of these large volume producing water electrolyzing systems in smaller settings is uneconomical.

Some commercially available water electrolyzing systems can also be overly complicated and expensive to maintain, which can be a problem if the system is to be operated only occasionally such as when a particular demand arises for electrolyzed water products. Additionally, known systems and methods for electrolyzing water are generally more efficient if operated continuously, or at least semi-continuously, which does not lend itself to portability. Portable systems tend to be relatively small and generally require water being input into the system to be substantially free of calcium and magnesium. All systems for electrolyzing water, but particularly systems that are relatively small in size, are generally prone to fouling caused by hard water. Water hardness varies significantly in different regions of the country, as well as locally within a geographical area. The water hardness can significantly impede the reliable electrolytic processing of water electrolyzing systems.

### OBJECTS AND SUMMARY OF THE INVENTION

In view of the foregoing, it is an object of the present invention to provide an electrolyzing system having a compact design that allows for portability of the system.

A further object of the present invention is to provide an electrolyzing system of the foregoing type that provides for simple, cost effective control of operation of the system.

Another object of the present invention is provide an electrolyzing system as characterized above that is able to operate efficiently and in an on-demand manner to produce a single batch of electrolyzed water.

A further object of the present invention is to provide an electrolyzing system of the foregoing type that is capable of being operated without any fixed plumbing.

These objects are not intended to limit the scope of the present invention. Moreover, other objects and advantages of the invention will become apparent upon reading the following detailed description and upon reference to the drawings.

### BRIEF DESCRIPTION OF THE SEVERAL VIEWS OF THE DRAWINGS

FIG. 1 is a front perspective view of an exemplary portable water electrolyzing system according to the present invention.

FIG. 2 is a top cross-sectional view of the water electrolyzing system of FIG. 1.

FIG. 3 is a partially cutaway rear perspective view of the water electrolyzing system of FIG. 1

FIG. 4 is an exploded rear perspective view of the water electrolyzing system of FIG. 1.

FIG. 5 is a schematic diagram of an exemplary electrical system for operating the water electrolyzing system of FIG. 1.

While embodiments encompassing the general inventive concepts may take various forms, there is shown in the drawings and will hereinafter be described various illustrative and preferred embodiments with the understanding that the present disclosure is to be considered an exemplification and is not intended to be limited to the specific embodiments.

### DETAILED DESCRIPTION

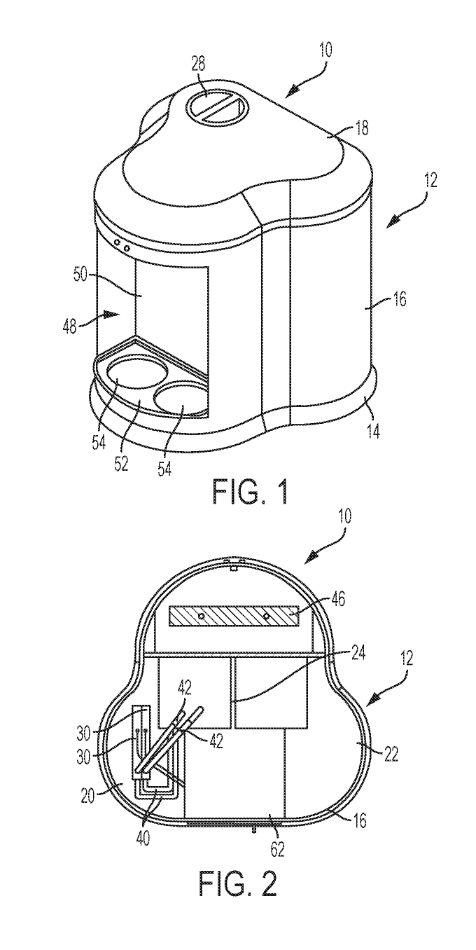

Referring to FIG. 1 of the drawings, there is shown an illustrative embodiment of a portable electrolyzing system 10 constructed in accordance with the teachings of the present invention. The illustrated portable electrolyzing system 10 is operable to electrolyze a solution of water and an alkali salt to produce acidic electrolyzed water and/or alkaline (i.e., base) electrolyzed water. Both acidic electrolyzed water (i.e., acid sanitizer) and alkaline electrolyzed water (i.e., base cleaner) have beneficial disinfecting and cleansing properties making them useful in a variety of applications including medical, agricultural, food processing and institutional. According to one embodiment, the water and salt solution is a saline or brine solution comprising water and sodium chloride. Depending on the process conditions, electrolysis of a brine solution comprising water and sodium chloride produces aqueous hypochlorous acid solution (e.g., an acid sanitizer) and aqueous sodium hydroxide solution (e.g., a base cleaner), each being an aqueous chemical solution. As will be appreciated by those skilled in the art, the present disclosure is not limited to electrolysis of any particular solution or use in any particular application.

The terms “aqueous solution” and aqueous chemical solution are used herein to describe a water-containing liquid that is produced by a cartridge, cell, system or method disclosed herein (e.g., acidic electrolyzed water and alkaline electrolyzed water), or will become so (e.g., fresh water, any intermediate substance entering, contained in, or leaving space 100). Though brine is an aqueous solution in the general sense of the term, brine is not an “aqueous solution” or an “aqueous chemical solution” as referenced in this application.

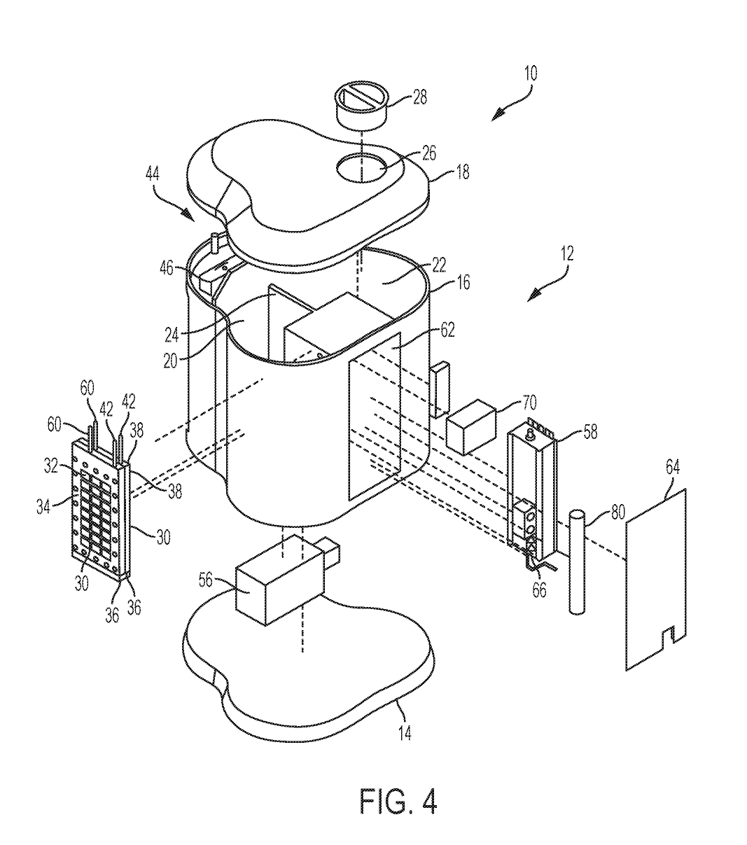

The portable electrolyzing system 10 may include a housing 12 within which the various components associated with the system 10 may be arranged. As discussed further below, the housing 112 may be relatively compact in size. A compact configuration can not only save on space, which can be a significant issue in smaller establishments in which the electrolyzing system 10 may be used such as restaurants and homes, but also allow the electrolyzing system 10 to be portable. In this case, the housing 12 includes a base 14, an upstanding exterior wall 16 and a cover 18. The interior of the housing 12 is configured to define a brine bath or compartment 20 and a separate fresh water compartment 22. As shown for example in FIG. 2-4, the brine compartment 20 and the fresh water compartment 22 in the interior of the housing 12 may be divided by an upstanding interior wall 24 such that each compartment is defined by a portion of the exterior wall 16 of the housing and the interior wall 24. In the illustrated embodiment, as best shown in FIG. 4, the cover 18 of the housing 12 has a fill opening 26 therein that communicates with the fresh water compartment 22 when the cover 18 is arranged on the housing 12 and through which fresh water may be introduced into the fresh water compartment 22 as described further below. The fill opening 26 has an associated cap 28 that can be used to close off the fill opening 26 when the fresh water compartment 22 is not being filled. Those skilled in the art will appreciate that the housing 12 may be configured to accommodate other ways of filling the fresh water compartment 22. For example, the fresh water compartment 22 may be filled by removing the entire cover 18 or the cover 18 may be pivotably attached to the housing 12 in a way that allows the cover to pivot between open and closed positions relative to the housing.

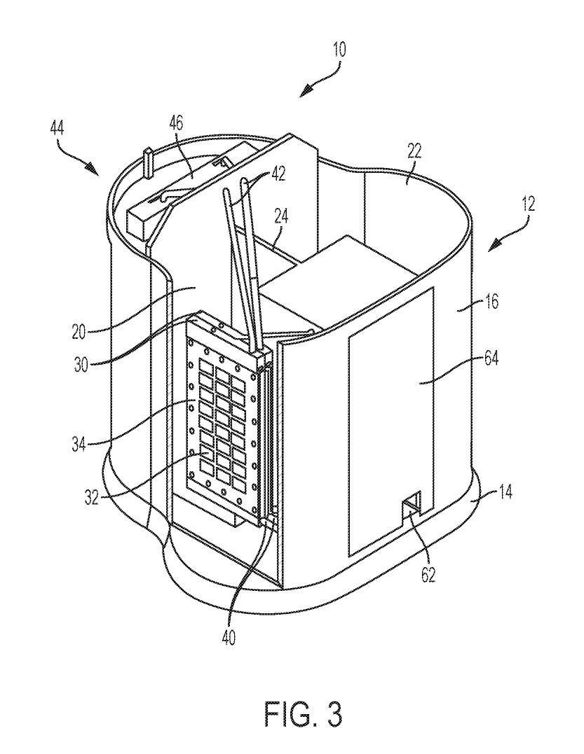

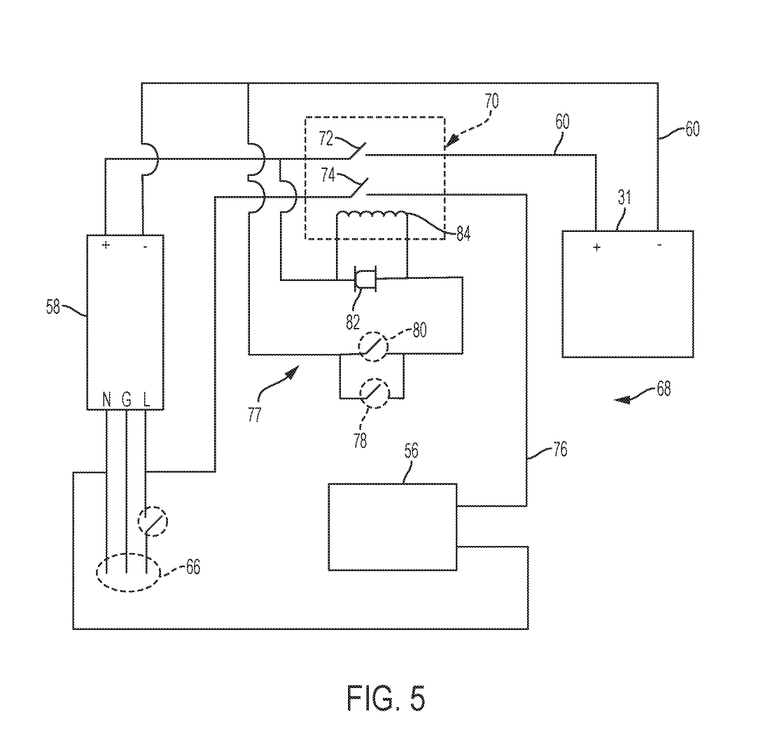

At least one electrolytic cartridge 30 having a positively charged electrode 31 (i.e., an anode) and at least one electrolytic cartridge 30 having a negatively charged electrode 31 (i.e., a cathode) may be arranged in the brine compartment 20 as shown in FIGS. 2 and 3. The electrodes 31 are arranged in the interior of the respective cartridges 30 and thus are not shown in FIGS. 2-5. However, the electrodes 31 are shown schematically in the circuit diagram of FIG. 5. The electrolytic cartridges 30 may be immersed in brine contained in the brine compartment 20 with substantially all sides of cartridges 30 open to the brine. As used herein, the term electrolytic cell consists of a pair of electrolytic cartridges 30, with one electrolytic cartridge 30 having a positively charged electrode 31 and the other electrolytic cartridge 30 having a negatively charged electrode 31. The use of an open brine compartment 20 with immersed electrolytic cartridges 30 eliminates the need for any obstructive intermediate chamber thereby allowing fluid to flow more freely through the system. It also eliminates the need for complex guides to direct the flow of fluid thereby simplifying the design as well as increasing efficiency.

The cartridges 30 are configured to electrolyze the brine in the brine compartment 20 and thereby draw in positively and negatively charged ions into the respective cartridges 30. To this end, each cartridge 30 may include an ion permeable membrane 32 (visible in FIGS. 3 and 4). According to one embodiment, ion permeable membranes 32 are provided on each side of the electrode 31 in each cartridge 30. Arranging membranes 32 on either side of each electrode 31 increases the production achievable with each electrode 31 by allowing ions to be drawn into the cartridge 30 from either side thereof. According to an alternative embodiment, each cartridge 30 may be configured with an ion permeable membrane 32 arranged on only one side of the electrode.

As shown in FIGS. 3 and 4, each cartridge 30 can include a cartridge housing 34 that supports both the associated electrode 31 and the ion permeable membranes 32. In this case, the cartridge housing 34 provides the respective cartridge 30 with a relatively thin, rectangular configuration with opposing substantially flat sides, one of which can be seen in FIGS. 3 and 4. Each side of the cartridge housing 34 may have a plurality of openings therein through which the brine may reach the surface of the membranes 32. In the illustrated embodiment, two cartridges 30 are supported in a side-by-side relationship in the brine compartment 20 of the system 10. Moreover, the cartridges 30 are supported such that sides of the cartridges that face each other are spaced apart a sufficient distance to allow brine to access the space between the two cartridges 30. This allows ions to enter into each cartridge 30 via the ion permeable membranes 32 on either side of the respective electrode 31 supported in the cartridge. While the two cartridges 30 are shown supported in a side-by-side relationship, those skilled in the art will appreciate that the cartridges 30 may be supported in other arrangements in the brine compartment 20. Moreover, while cartridges 30 having housings with generally rectangular configurations are shown, those skilled in the art will appreciate that other configurations could also be used.

The electrode 31 contained in each cartridge 30 is generally constructed of a conductive substance, which generally is a metal. In certain embodiments the anode, i.e., the positively charged electrode 31, is constructed of a substance that is compatible with aqueous acidic solutions (e.g., acidic electrolyzed water). In a preferred embodiment, the anode is constructed of titanium coated with a mixed metal oxide coating, e.g., a coating of oxides of certain metals. In certain embodiments, the mixed metal oxide coating comprises oxides of tantalum, ruthenium, and iridium. In certain embodiments of the cathode, i.e., the negatively charged electrode 31 is constructed of a conductive substance that is compatible with aqueous alkaline solutions. In a preferred embodiment, the cathode is constructed of titanium or an alloy thereof. The electrode 31 may have, e.g., a solid plate or dimpled construction, or otherwise constructed to provide current as necessary to perform the electrolytic reactions described herein.

To allow for the flow of ions towards the electrode plate 31, the membranes 32 are ion permeable. In particular, cartridges 30 having negatively charged electrodes 31 are equipped with positive ion exchange membranes 32, i.e., cation selective membranes. In certain embodiments, cation selective membranes allow alkali ions to pass through. In a preferred embodiment, the cation selective membrane(s) allow sodium ions to pass through. In a preferred embodiment, the cation selective membrane(s) is/are constructed of a sulfonated tetrafluoroethylene based fluoropolymer-copolymer. Cartridges 30 having positively charged electrodes 31 are equipped with negative ion exchange membranes 32, i.e., anion selective membranes. In certain embodiments, anion selective membranes allow, among others, halide ions to pass through. In a preferred embodiment, the anion selective membrane(s) allow, among others, chloride and/or chlorate ions to pass through. In a preferred embodiment, the anion selective membrane(s) are constructed of a polytetrafluoroethylene cloth having a sulfonated tetrafluoroethylene coating. According to a preferred embodiment, membranes 18 have a rigid yet porous structure.

Additional information regarding the structure and operation of embodiments of the cartridges, electrodes and membranes can be found in U.S. Pat. Nos. 8,753,489 and 9,103,043 and pending U.S. Provisional Application Nos. 62/174,791 and 62/111,980 the disclosures of which are incorporated herein by reference.

As shown in FIG. 4, each of the electrolytic cartridges 30 has a fresh water inlet 36 (i.e., inlet of the space) that directs fresh water into a space in the cartridge 30 between the membranes 32 and the electrode 31. In the cartridge 30, the fresh water mixes with the ions drawn into this space to form either aqueous acidic solution (in the cartridge 30 with the positively charged electrode 31) or aqueous alkaline solution (in the cartridge 30 with the negatively charged electrode 31). Each cartridge 30 also has an outlet 38 through which the respective aqueous chemical solutions (aqueous acidic solution or aqueous alkaline solution) can exit the cartridges 30. The space in the cartridge 30 in which the fresh water mixes with the ions is sealed such that, when submerged in brine, the only flow path of ions into the cartridge 30 is via a membrane 32, thus only a certain species of ions (i.e., either positively charged ions or negatively charged ions) can pass into the interior of a particular cartridge 30.

Each cartridge 30 can be considered to be self-contained in that it merely needs to be immersed in the brine compartment 20, appropriately charged, and connected to the fresh water supply in the fresh water compartment 22 and chemical outlets, as long as at least two cartridges 30 are present, with one of the cartridges having a positively charged electrode and the other cartridge having a negatively charged electrode. However, multiple cartridges 30 of each may be included in a particular system, and an equal number of each may not be present. While the illustrated embodiment has the fresh water inlet 36 at a lower end of each cartridge 30 (relative to the cartridge as supported in the brine compartment) and the aqueous chemical solution outlet 38 at an upper end of each cartridge 30, the cartridges 30 could be configured such that water is introduced and aqueous chemical solution is drawn off from the same end of the cartridges.

To allow for the transfer of fresh water from fresh water compartment 22 to the inlet 36 of each cartridge 30, the inlet 36 of each cartridge is connected to a fresh water supply line 40 (a portion of which can be seen in FIG. 3) that communicates with the fresh water compartment 22. Additionally, the outlet 38 of each cartridge 30 is connected to a chemical fill line 42 that is configured to direct the aqueous chemical solutions exiting the cartridges 30 to a dispensing system 44. In this case, as shown for example in FIG. 1, the dispensing system 44 is provided at a forward end of the housing 12 and includes a manifold 46 (see FIG. 3) to which the chemical fill lines 42 from the cartridges 30 are connected. The manifold 46 is arranged in an upper portion of the forward end of the housing 12 above a dispensing station 48 that is best shown in FIG. 1. The illustrated dispensing station 48 includes a recessed portion 50 in the exterior wall 16 at the forward end of the housing that defines a platform 52 beneath the manifold 46 on which one or more containers to be filled with aqueous chemical solution may be placed. The manifold 46 may be configured to direct the aqueous chemical solution received from the chemical fill lines 42 in a downward direction towards the platform 52 of the dispensing station 48 and into the one or more containers positioned there.

In the illustrated embodiment, the platform 52 of the dispensing station 48 is configured with two dispensing positions 54 that in this case are arranged side-by-side beneath the manifold 46 as shown in FIG. 1. Each dispensing position 54 is sized to receive a portable container, such as a bottle, which an operator desires to fill with aqueous chemical solution. According to one embodiment, the two dispensing positions 54 may be sized and configured identically. For example, each dispensing position 54 may be configured to receive a container having a maximum capacity of approximately one liter.

In the illustrated embodiment, the manifold 46 is configured to deliver alkaline electrolyzed water to one of the dispensing positions 54 and acidic electrolyzed water to the other dispensing position 54. It will be appreciated that the dispensing station 48 may have a configuration different than that shown in the drawings. For example, one of the dispensing positions 54 may be relatively larger than the other (i.e., capable of receiving a relatively larger volume container. Additionally, the dispensing positions 54 may be oriented differently with respect to each other, such as spaced further apart or separated by a divider wall. According to an alternative embodiment, the dispensing system 44 may be configured to direct some or all of the aqueous chemical solution produced by the cartridges 30 to a discharge hose that may be used to fill a larger container such as a bucket that is not positioned in the dispensing station 48. The dispensing system 44 may be configured to direct one or both of acidic electrolyzed water and alkaline electrolyzed water to the discharge hose.

For driving movement of the fresh water in the fresh water compartment 22 to the respective inlets 36 of the cartridges 30, the electrolyzing system 10 includes a pump 56. More specifically, the pump 56 (shown schematically in FIG. 4) is configured and arranged to be in fluid communication with the fresh water inlet 36 of each of the cartridges 30 arranged in the brine compartment 20. Furthermore, the pump 56 is configured and arranged to be in fluid communication with the fresh water compartment 22 of the housing 12 and is operable to draw fresh water out of the fresh water compartment 22 and direct it under pressure to the cartridge inlets 36 via the fresh water supply lines 40. The illustrated pump 56 is electrically powered and is arranged in a compartment in a lower portion of the housing 12, beneath the brine and fresh water compartments 20, 22. The pump 56 is configured to produce a flow rate and pressure sufficient to deliver fresh water from the fresh water compartment 22 to the inlet 36 of each cartridge 20, move the water through the interior of each cartridge 20 where it picks up ions and then deliver the resultant aqueous chemical solution to the manifold 46 via the respective cartridge outlet 38 and the associated chemical fill line 42. According to one embodiment, the pump 56 is configured to produce a flow of approximately 0.27 to approximately 0.33 gallons per minute.

For supplying electric power to the pump 56 as well as the electrodes 31 contained in the cartridges 30, the portable electrolyzing system 10 includes an electrical power supply 58. In the illustrated embodiment, the power supply 58 is electrically connected to each of the electrodes 31 via lines 60 as shown in FIG. 4. These lines 60 extend to the power supply 58 which in this case is arranged in a power compartment 60 in a rear portion of the housing 12 between the brine compartment 20 and the fresh water compartment 22. To provide access to the power supply 58, the exterior wall 16 of the housing 12 includes a removable panel 64 that when removed provides an opening into the power compartment 62. The power supply 58 has an attached power cord 66 which can be used to connect, such as via an electrical outlet, the power supply 58 to the existing electrical system in the location in which the portable electrolyzing system 10 is to be used. According to one embodiment, the power supply 58 is configured to generate 24V.

For controlling the operation of the pump 56 and the electrodes 31 in the cartridges 30 in the brine compartment 20, the connection of the power supply 58 to the electrodes 31 in the cartridges 30 and pump 56 may be directed by a control system including a control circuit 68. In particular, the control system may be configured to provide automatic control of power to the pump 56 and the electrodes 31 based on flow of fresh water to the electrode 31 in this case through the freshwater supply line 40. As shown in FIG. 5, the control circuit 68 may include a relay 70 that is interposed between the power supply 58 and the pump 56 and electrodes 31. The relay 70 may include one switch 72 in the line 60 to the electrodes 31 and one switch 74 in the line 76 to the pump 56. In the illustrated embodiment, the switches 72, 74 in this relay 70 are in a normally open position that interrupts the flow of power from the power supply 56 to the electrodes 31 (via line 60) and the pump 56 (via line 76).

The closing and opening of the relay 70 is controlled by a relay control circuit 77 that includes a manual on/off switch 78 and a flow switch 80 as shown in FIG. 5. The flow switch 80 is configured to close upon detection of the flow of fresh water from the fresh water compartment 22 to the cartridges 30, such as in the fresh water supply line 40. The flow switch 80 is also shown in FIG. 4. Referring again to FIG. 5, the relay control circuit 77 is configured with the on/off switch 78 and the flow switch 80 in parallel such that closing of either the on/off switch 78 or the flow switch 80 completes the relay control circuit 77 allowing current to flow from the power source 58 to an inductor coil 84. The flow of current to the inductor coil 84 closes the relay switches 72, 74 permitting the flow of power from the power source 58 to the electrodes 31 in the cartridges 30 and the pump 56. In this case, an indicator light 82 is provided in the relay control circuit 77 that illuminates when there is current flowing in the relay control circuit 77. Thus, the indicator light 82 illuminates when power is flowing to the electrodes 31 and the pump 56.

The on/off switch 78 is configured to be manually operated such that an operational cycle of the electrolyzing system 10 may be begun by an operator actuating the switch to the closed position. As noted above, the closing of the switch 78 actuates the relay 70 and allows power to be delivered to the electrodes 31 and the pump 56. The pump 56 then starts-up and begins moving fluid from the fresh water compartment 22 to the cartridges 30. This initial flow of fluid to the cartridges 30 that results from actuation of the on/off switch 78 is sufficient to actuate the flow control switch 80 and close it. Thus, the on/off switch 78 need only close for a short period of time when actuated by an operator to start operation of the electrolyzing system 10. Once the pump 56 has been started, the on/off switch 78 may reopen and current through the relay control circuit 77 is then controlled by the flow control switch 80. When the fresh water compartment 22 is emptied of fresh water, flow of fresh water to the cartridges 30 will cease and the flow control switch 80 will deactivate. This will open the relay control circuit 77 halting the flow of current to the inductor coil 84 resulting in the opening of the switches 72, 74 and the halt of power flow to the electrodes 31 and the pump 56.

The control circuit 68 of the present disclosure provides a simple, cost effective way to control operation of the electrolyzing system 10, in particular to control the flow of electricity and fluid to the cartridges 30. The control system does not require any complicated electronics, such as microelectronic controls are necessary. Likewise, no complicated flow control valves are required so long as the pump 56 produces sufficient flow of fresh water to and through the cartridges 30.

To operate the electrolyzing system 10 of the present disclosure, a user may manually fill the fresh water compartment 22 with fresh water from a separate supply thereof. Any supply of fresh water can be used including, for example, tap or bottled water. The fresh water can be introduced into the fresh water compartment 22 through the fill opening 26 in the cover 18 of the housing 12. Once filled, the operator may replace the cap 28 in the fill opening 26. While the fresh water compartment 22 will generally need to be filled prior to each operating cycle of the electrolyzing system 10, the brine in the brine compartment 20 is usable for multiple cycles of the electrolyzing system 10. If it is necessary to refill or replace the brine in the brine compartment 20, salt can be mixed with water to produce brine for the brine compartment 20. The brine may be mixed in a container outside of the electrolyzing system 10 and then poured by the user into the brine compartment 20 by lifting the cover 18 off of the housing 12. The salt for preparing the brine may be provided in a package or bag that may be supplied with the electrolyzing system 10.

In order to provide an operator with an indication of the fluid levels in the brine compartment 20 and the fresh water compartment 22, the housing 12 of the electrolyzing system 10 may optionally include level indicator windows. In particular, separate level indicator windows could be provided on the housing so as to allow an operator to see the amount of fluid in the brine compartment 20 and the fresh water compartment. One convenient location for the level indicator windows may be in the recessed portion 50 of the exterior wall 16 at the forward end of the housing that defines the dispensing station 48 as this is a location that is readily visible to an operator using the electrolyzing system 10. Of course, the level indicator windows could be provided in other locations as well.

Prior to actuating the electrolyzing system 10, the user may also position containers on the dispensing station platform 52 to receive the aqueous chemical solutions produced by the electrolyzing system. For example, the user may position one container to receive acidic electrolyzed water and one container to receive alkaline electrolyzed water. Once the containers have been placed and the fresh water compartment 22 filled, the user may actuate the electrolyzing system 10 via the on/off switch 78. As noted above, upon actuation the electrolyzing system 10 will operate until the fresh water compartment 22 is empty at which time the flow switch 80 will deactivate the relay control circuit 77 cutting off the flow of power to the electrodes 31 and the pump 56.

According to an alternative embodiment, the electrolyzing system may optionally be configured to automatically refill the fresh water compartment 22, for example either at the end of or at the start of each operating cycle. For instance, when the flow switch 80 signals that power should be cut off to the electrodes 31 and the pump 56 because the fresh water compartment 22 is empty, a solenoid valve could open in a pressurized fresh water supply line that communicates with the fresh water compartment 22. Fresh water would then flow into the fresh water compartment 22 until a sensor, such as a fluid level sensor, indicated that the fresh water compartment 22 was filled with fresh water. The fluid level sensor would then send a signal that would deactivate or close the solenoid valve in the fresh water supply line. Alternatively, the automatic filling of the fresh water compartment could occur at the start of each operating cycle before the pump 56 starts the flow of water to the cartridges 30.

In one embodiment, fresh water that is relatively soft may provide improved operation of the electrolyzing system 10. To account for this, information regarding the hardness and/or softness of the water to be used in the fresh water compartment 22 may be gathered prior to operating the electrolyzing system 10. If this information indicates that the water to be used is too hard, provision may be made to soften the water that will be used in the electrolyzing system 10. For example, prior to using the system a test may be performed on the water supply that will be used to provide fresh water for the electrolyzing system. If the water is too hard, for example below approximately 10 grains of hardness per gallon, a sodium carbonate may be added to the water to be used in the fresh water compartment. Moreover, the sodium carbonate may be provided in small, premeasured packages that are included with the electrolyzing system 10 and can be added to the water at the time of use by an operator. Alternatively, a commercially available water softening system may be provided on the water source that will be used to provide fresh water for the electrolyzing system.

Since both the fresh water compartment 20 and the brine compartment 22 may be filled manually, the electrolyzing system 10 need not be attached to any fixed plumbing. Thus, the electrolyzing system is completely portable. Moreover, the configuration of the housing 12 provides a compact, space-saving design that can fit into a small space. As the electrolyzing system 10 can be used only on an as needed basis to make a single batch of aqueous chemical solutions at a time, it is much more efficient than large scale electrolyzing systems. The small size, portability and on-demand operation of the electrolyzing system 10 of the present disclosure provides on-the-spot convenience that makes the electrolyzing system of the present disclosure well suited for use in applications such as restaurants, grocery stores or other establishments where food is handled, service stations, retail stores, smaller hotels and nursing homes and even households. However, the electrolyzing system 10 is not limited to these applications. For example, multiple units of the electrolyzing system of the present disclosure could be provided in a larger facility.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An electrolyzing system for electrolyzing a brine solution, the system comprising:
a housing having an interior configured to define a brine compartment and a fresh water compartment;
a dispensing system arranged in the housing and configured to discharge aqueous chemical solution into a portable container;
a first electrolytic cartridge arranged in the brine compartment including an electrically charged electrode and an ion permeable membrane, the first electrolytic cartridge being configured with an inlet in fluid communication with the fresh water compartment and an outlet that is fluid communication with the dispensing system;
a pump in fluid communication with the fresh water compartment and operable to direct fresh water from the fresh water compartment to the inlet of the first electrolytic cartridge, move the fresh water through the first electrolytic cartridge, and direct aqueous chemical out of the outlet of the first electrolytic cartridge and to the dispensing system, the pump being electrically powered;
a power supply for supplying electric power to the pump and the electrode; and
a control system for controlling the supply of electric power from the power supply to the pump, the control system being configured to direct electric power from the power supply to the pump when flow of fresh water from the fresh water compartment to the inlet of the first electrolytic cartridge is detected and configured to stop directing electric power from the power supply to the pump when flow of fresh water from the fresh water compartment to the inlet of the first electrolytic cartridge is not detected.

2. The electrolyzing system according to claim 1 wherein the control system controls supply of electric power to the electrode and wherein the control system is configured to direct electric power from the power supply to the electrode when flow of fresh water from the fresh water compartment to the inlet of the first electrolytic cartridge is detected and configured to stop supplying electric power to the electrode when flow of fresh water from the fresh water compartment of the inlet of the first electrolytic cartridge is not detected.

3. The electrolyzing system according to claim 2 wherein the control system further includes a manual on/off switch movable between open and closed positions and configured so as to direct electric power from the power supply to the pump and the electrode when in the closed position.

4. The electrolyzing system according to claim 3 wherein the control system comprises a control circuit including the on/off switch and a flow switch which is configured to direct electric power from the power supply to the electrode when flow of fresh water from the fresh water compartment to the inlet of the first electrolytic cartridge is detected and configured to stop supplying electric power to the electrode when flow of fresh water from the fresh water compartment of the inlet of the first electrolytic cartridge is not detected, with the on/off switch and the flow switch being arranged in parallel.

5. The electrolyzing system according to claim 4 wherein the on/off switch and the flow switch control a relay that includes a first switch that controls the flow of electrical power from the power supply to the pump and a second switch that control the flow of electrical power from the power supply to the electrode.

6. The electrolyzing system according to claim 1 wherein the first electrolytic cartridge is arranged in a cell with a second electrolytic cartridge, the first electrolytic cartridge being configured to be positively charged by the power supply, the ion permeable membrane of the first electrolytic cartridge being a cation permeable membrane, the second electrolytic cartridge including an electrode configured to be negatively charged by the power supply and having an anion permeable membrane, the second electrolytic cartridge having an inlet in communication with the fresh water compartment and an outlet in communication with the dispensing system.

7. The electrolyzing system according to claim 6 wherein the dispensing system is configured such that aqueous chemical solution from the first electrolytic cartridge is discharged to a first dispensing position and aqueous chemical solution from the second electrolytic cartridge is discharged to a second dispensing position.

8. The electrolyzing system according to claim 7 wherein the first dispensing position and the second dispensing position are defined by the housing and each is configured to receive a portable container.

9. The electrolyzing system according to claim 1 wherein the first and second dispensing positions are arranged on a platform defined by the housing.

10. The electrolyzing system according to claim 9 wherein the platform is defined by a recess in an exterior wall of the housing.

11. The electrolyzing system according to claim 7 wherein the dispensing system is configured to discharge aqueous chemical solution downwards towards the first and second dispensing positions.

12. A method for electrolyzing a brine solution, the method comprising:
providing a housing having an interior configured to define a brine compartment and a fresh water compartment;
immersing a first electrolytic cartridge in a brine solution in the brine compartment, the first electrolytic cartridge including an electrically charged electrode and an ion permeable membrane, the first electrolytic cartridge being configured with an inlet in fluid communication with the fresh water compartment and an outlet;
directing aqueous chemical solution from the outlet of the first electrolytic cartridge to a dispensing system arranged in the housing and configured to discharge aqueous chemical solution into a portable container;
providing a pump in fluid communication with the fresh water compartment and operable to direct fresh water from the fresh water compartment to the inlet of the first electrolytic cartridge, move the fresh water through the first electrolytic cartridge, and direct aqueous chemical out of the outlet of the first electrolytic cartridge and to the dispensing system, the pump being electrically powered;
providing a power supply for supplying electric power to the pump and the electrode; and
controlling the supply of electric power from the power supply to the pump so as to direct electric power from the power supply to the pump when flow of fresh water from the fresh water compartment to the inlet of the first electrolytic cartridge is detected and so as to stop directing electric power to the pump when flow of fresh water from the fresh water compartment to the inlet of the first electrolytic cartridge is not detected.

13. The method according to claim 10 further including the step of controlling the supply of electric power to the electrode so as to direct electric power from the power supply to the electrode when flow of fresh water from the fresh water compartment to the inlet of the first electrolytic cartridge is detected and so as to stop supplying electric power to the electrode when flow of fresh water from the fresh water compartment of the inlet of the first electrolytic cartridge is not detected.

14. The method according to claim 13 further including the step of providing a manual on/off switch movable between open and closed positions and configured so as to direct electric power from the power supply to the pump and the electrode when in the closed position.

15. The method according to claim 13 wherein the first electrolytic cartridge is arranged in a cell with a second electrolytic cartridge, the first electrolytic cartridge being configured to be positively charged by the power supply, the ion permeable membrane of the first electrolytic cartridge being a cation permeable membrane, the second electrolytic cartridge including an electrode configured to be negatively charged by the power supply and having an anion permeable membrane, the second electrolytic cartridge having an inlet in communication with the fresh water compartment and an outlet in communication with the dispensing system.

16. The method according to claim 15 further including the steps of discharging aqueous chemical solution from the first electrolytic cartridge to a first dispensing position via the dispensing system and discharging aqueous chemical solution from the second electrolytic cartridge is discharged to a second dispensing position via the dispensing system.

17. The method according to claim 16 wherein the first dispensing position and the second dispensing position are defined by the housing and each is configured to receive a portable container.

18. The method system according to claim 13 wherein the first and second dispensing positions are arranged on a platform defined by the housing.

19. The method according to claim 16 wherein the aqueous chemical solution is discharged downwards towards the first and second dispensing positions.

20. The method according to claim 14 further including the step of initiating electrolyzing the brine solution by actuating the on/off switch.
